(19) United States
(12) Patent Application Publication
(10) Pub. No.: US 2010/0032375 A1
(43) Pub. Date: Feb. 11, 2010

(54) REVERSE OSMOSIS ENHANCED RECOVERY HYBRID PROCESS

(76) Inventors: Venkataraman Jagannathan, Canonsburg, PA (US); Ravi Chidambaran, Canonsburg, PA (US); Manoj Sharma, Canonsburg, PA (US)

Correspondence Address: BUCHANAN INGERSOLL & ROONEY PC, P.O. BOX 1404, ALEXANDRIA, VA, 22313-1404, US

(21) Appl. No.: 12/536,303

(22) Filed: Aug. 5, 2009

Related U.S. Application Data
(60) Provisional application No. 61/086,196, filed on Aug. 5, 2008.

(51) Int. Cl. C02F 1/44; C02F 5/02; C02F 1/66

(52) U.S. Cl. 210/638; 210/195.2

(57) ABSTRACT

Disclosed is a high-recovery integrated recycling process to treat water and waste water having high hardness, silica, and other contaminants to facilitate operation of a reverse osmosis (RO) membrane at very high overall recovery when treating waste water containing high concentration of sparingly soluble inorganic salts like hardness, silica, and other components such as silica, etc. The RO membrane continuously operates in low or conservative recovery conditions, but can still achieve a very high overall system recovery. The process includes precipitation softening in a softening clarifier where the scale forming salts are reduced followed by filtration and reverse osmosis. The precipitated salts are removed as underflow from the clarifier. The softened or partially softened water is then filtered by a conventional filtration system, for example by a media filter. This is then fed to a reverse osmosis membrane unit that is designed to operate at an appropriate recovery to avoid scaling and fouling. Normally the recovery can be maintained quite low, for example at 50 to 60% of the feed flow.

### CROSS-REFERENCE TO RELATED APPLICATIONS

This application claims priority to pending U.S. Provisional Patent Application No. 61/086,196, filed on Aug. 5, 2008, and incorporated by reference herein.

### BACKGROUND OF THE INVENTION

1. Field of the Invention

Embodiments of the invention related to method to treat waste water containing large amount of scale-forming inorganic salts and other foulants through a reverse osmosis membrane process to achieve high recovery and minimize water discharge.

2. Background of the Art

Conventional processes that include reverse osmosis (RO) units are limited in terms of overall recovery based on the level of contamination of sparingly soluble ions and their salts like hardness (including, for example, calcium, magnesium, etc., associated with bicarbonates, sulfates, etc.), as well as components such as silica. These ions contribute to scaling within the membrane unit; therefore, the systems are operated within recovery limits that require these salts to remain within their solubility parameters. Conventional systems must therefore sacrifice water recovery to maintain membrane flux and avoid scaling.

Zero liquid discharge and waste volume reduction have become very important requirements for industries to satisfy permit and other local environmental requirement. For example, cooling tower blow down water normally contains a high hardness and silica levels. The treatment scheme for waste volume reduction on such types of water using an RO membrane process would mainly consist of a softening clarifier followed by filtration and RO. The softening clarifier performance becomes the most important part of the process. Its efficiency and performance in precipitating and reducing scale forming salts of, for example, calcium, magnesium, barium, and strontium, and also in reducing soluble silica and similar solubles, determines the RO recovery and thus the final waste water volume.

Many existing plants including RO are designed to require highly efficient and reliable performance of the softening clarifier for a given blow down water analysis. Any change in water analysis would directly impact the clarifier softening performance. Similarly, any change in the ambient conditions, for example temperature, would affect the performance of the clarifier.

Many current designs are based on reduction of hardness and silica to a low level; however in practical operation of the plant the desired performance is quite challenging to achieve. It has been observed that in the softened water where calcium hardness is expected to be about 35 mg/l as CaCO₃, the actual hardness achieved could be anywhere from 60 to 100 mg/l or more. Situations have also been observed where silica reduction needs to be 5 to 10 mg/l, but the level achieved is about 40-50 mg/l as SiO₂. Thus an RO unit treating the above soft water which was originally designed for 80 to 85% recovery can now only operate only at about 50 to 60% recovery, therefore producing more waste water. Thus the design performance and actual performance of the plant becomes vastly different.

Also in the conventional RO membrane process to achieve a higher recovery there are stringent minimum velocity conditions that must be maintained to avoid scaling even if the chemistry allows higher recovery. When the recovery is pushed under this case, the RO program does not allow higher recovery because doing so would cause a violation of velocity guidelines laid down by the membrane manufacturers. When the RO unit is designed ignoring these guidelines, irreversible flux decline is observed because of high recovery, inadequate flow and low velocities.

### BRIEF SUMMARY OF THE INVENTION

Embodiments of the invention provide a new method for treating an aqueous waste water solution such as a cooling tower blow down water containing high hardness and sparingly soluble inorganic salts, soluble silica, and to achieve high recovery using a reverse osmosis membrane. In cooling tower blow down water treatment by reverse osmosis, the dispersant chemicals added in the cooling water do not allow efficient media filtration as the colloids and suspended solids stay dispersed by the dispersant. With the addition of a softening clarifier, the effect of dispersant is reduced (due to higher pH), resulting in improved media filter performance.

One embodiment provides a multi step process, comprising flow through a softening clarifier for metals precipitation, coprecipitation and settling followed by filtration and reverse osmosis. The precipitated salts are taken out of the clarifier as underflow sludge for further treatment. The soft water from the clarifier, which is low in suspended solids as it is already clarified, is further pH reduced and filtered by a conventional media filter or any other type of filter to make it suitable for RO feed. The RO is operated at a very low recovery rate, for example, 50 to 60% producing permeate from the low pressure side of the membrane. The concentrate from the high pressure side of the membrane is partly recycled back to the front end of the softening clarifier and a portion of it is bled off for disposal.

As the RO would be operating theoretically at a lower side of recovery compared to membrane suppliers' recommended recovery range it is not essential for the softening clarifier to reduce hardness, silica etc to very low level. The inventive method does not require a high quality of performance from the softening clarifier and any spikes etc in the quality of soft water are not a critical to the process.

This is a major benefit for ease of operation, reliability and need of high level of attention by the operators. For example, at 50% RO recovery, a silica level as high as 50 to 60 mg/l in the soft water is acceptable. Similarly hardness reduction to a very low level is not required because the RO is operating at only about 50% recovery. Because most of the solids are already removed by a clarifier, a simple conventional media filtration should be more than enough to meet the RO performance needs unless there is a specific requirement for other types of filtration. Also by taking a reject bleed from the RO concentrate side for disposal, the Total Dissolved Solids (TDS) in the softening clarifier is considerably lower than the TDS of the RO concentrate.

### DETAILED DESCRIPTION OF THE FIGURE

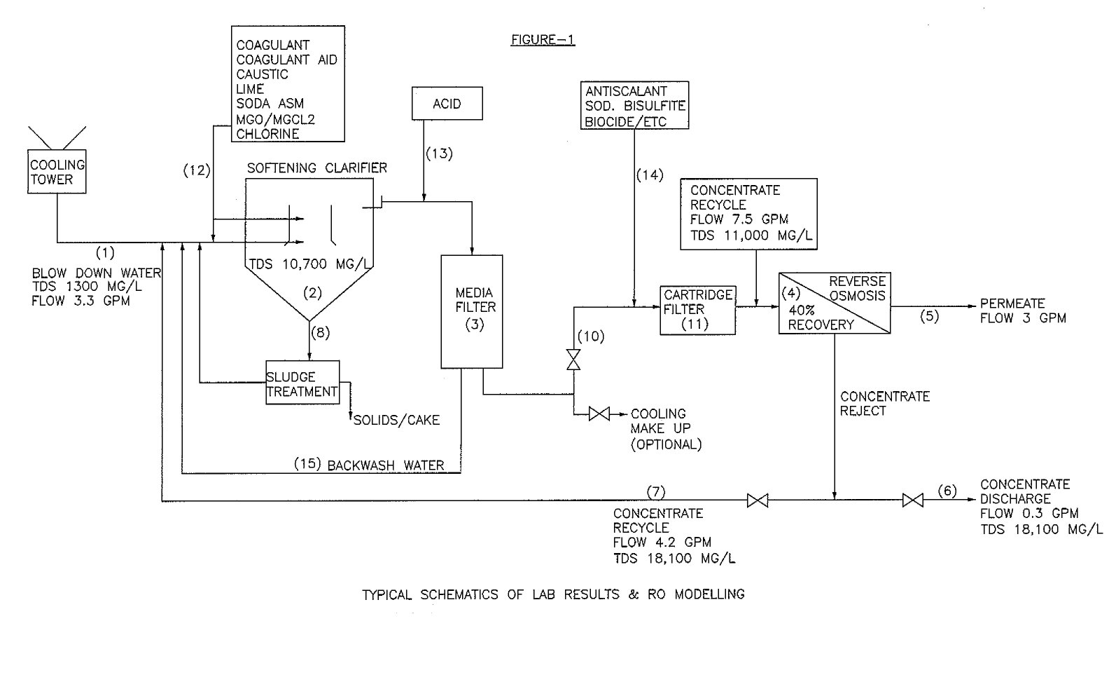

FIG. 1 shows a typical representation of the disclosed process.

### DETAILED DESCRIPTION OF THE INVENTION

Provided herein is a process for water treatment and waste recycling to achieve a relatively high overall system recovery with no limits on sparingly soluble salts while operating well within conservative design limits of reverse osmosis units. A conventional approach for high recovery is to achieve the entire recovery through one pass. By operating at high recovery, the flow on the concentrate side is quite low, resulting in localized scaling and fouling. This increases the pressure drop and there are chances of RO element getting telescoped. The telescoping further reduces the flow through some portion of the membrane, causing irreversible increased scaling and fouling. Even if the pretreatment is very good, due to high recovery in a single pass, there are good chances of membrane scaling and failure.

In the process described herein, the high recovery is achieved by multiple passes through the RO by recirculation, enabling the RO to actually operate at a low hydraulic recovery. This allows a good concentrate flow to be maintained all the time across the membrane permitting a good cross flow to dilute and flush the scalant.

A preferred embodiment comprises the steps of softening sparingly soluble salts of the feed water (1) by chemical precipitation in a softening clarifier (2) to reduce hardness and also to reduce other sparingly soluble salts, including but not limited to silica, present in the feed water. Softening and silica reduction will be achieved by addition of lime, dolomite, caustic, soda ash, magnesium oxide, magnesium chloride, or other composition known to those of skill in the art to be effective for softening and/or silica reduction (12) separately or in combination as per the process requirement. The water can also be chlorinated if necessary or desirable.

The precipitated sparingly soluble salts along with other suspended solids are allowed to settle and separate in the clarifier. Coagulant and coagulant aid is also added (12) to aid this process of separation in the clarifier. The settled solids are taken out as an underflow (8) for further sludge treatment as required.

The softened and clarified water from the clarifier with reduced hardness and silica is then slightly acid neutralized (13) if required to stop the precipitation process. The water can also be chlorinated if necessary.

The clarified water with very low suspended solids/turbidity (9) is then filtered through a single stage or two stage media filter (3) to make it suitable for RO feed. Other types of filtration can also be used, including but not limited to microfiltration (MF) or ultrafiltration (UF). The filter is back washed periodically and the waste wash water (15) is returned to the softening clarifier for recycling.

The filtered water (10) is then passed through a pre-RO cartridge filter (11) and then fed to a single pass reverse osmosis unit (4) operating at a low 40 to 60% recovery recommended or at a recovery which would maintain the scale forming salts in soluble condition on the high pressure concentrate side of the RO membrane. Low recovery is maintained at the RO so as not to demand a high performance of the softening precipitation process or to demand a very fine filtration of the RO feed. Low recovery would also ensure a higher velocity on the concentrate side and thus allowing for rapid flushing of the foulants on the concentrate side.

The flux for the RO membrane is also maintained at a low 8 to 15 GFD or about as per the membrane supplier guidelines, which keep the RO booster pump pressure low. Thus the RO will be operating at a very conservative flux, recovery, and pressure ensuring longer life and low fouling. Under these guidelines of operation, the feed water to the RO can be dosed with antiscalant, sodium bisulfite, biocide, or other additives (14) if required.

The RO membrane can be a brackish water membrane, a seawater membrane, or any of the modified version of RO membrane such as plate, disc or such similar types. The permeate (5) from the low pressure side of the membrane is treated water and can be further used within the plant as applicable.

A portion of the RO concentrate reject (7) is recycled back to the front end of the softening clarifier. There will also be an RO concentrate blow down (6) for disposal, which can be determined based on the overall RO recovery desired. Recovery will also be based on consideration of what levels of TDS the softening clarifier can effectively operate and also on osmotic pressure limitation of the membrane.

Allowing direct disposal of the blow down of the RO concentrate maintains a considerable lower TDS in the softening clarifier. For example, at 40% RO recovery the TDS in the clarifier is about 40% lower than the RO concentrate. Please see table 1 and 2 to review laboratory test results confirming these values.

One advantage of this process is that operation of the RO at a low actual recovery does not require the softening clarifier to operate to a high performance level. Therefore, there is no need to bring down silica and hardness to very low level like in some of the competing process. Considering solubility of silica as SiO₂ at about 130 to 140 mg/l at a pH of 7 or about 7, it should be very sufficient even for the softening clarifier to bring down the influent silica to a 50 to 60 mg/l level or about in the softening clarifier. In addition, as the operation is close to neutral pH various antiscalant can be effectively used if required for further enhancing the recovery.

Typically the process will produce concentrate reject from the RO unit that will be in a pH range of 8 or about 8, and silica as SiO₂ will also be in an approximate amount of 140 mg/l. This will enable the RO reject waste water to be easily treatable in further process like thermal evaporator or crystallizer in a ZERO liquid discharge plant. Also there will not be any issue of silica precipitation or silica deposit and will not require any pH adjustment if the waste water needs to be disposed of as liquid waste.

In one embodiment of the invention, the RO process operates at less than or equal to 80% recovery based on RO feed flow and total recovery is at least about 98% overall recovery relative to system makeup feed flow. In further embodiments of the invention, the RO process operates at less than or equal to 70%, 60%, 50%, or 40% recovery based on RO feed flow and total recovery is at least about 60%, at least about 70%, about least about 80%, at least about 90%, or at least about 95%. Those skilled in the art will recognize, with the benefit of this disclosure, that that the total recovery is likely to vary based on the quality of the feed water. System makeup feed flow is the feed water entering the system, not including any recycled flows.

Preferred embodiments do not require a very low hardness reduction, as the RO need not be operated at high pH like competing process to achieve high recovery. In short we are not expecting highly efficient performance from the softening clarifier is therefore not necessary

### Examples

The concept for this process was explored by examination of various softening clarifier's presently treating high TDS cooling tower blow down of about 12,000 mg/l at power plants in California. Similarly, softening clarifiers treating waste water of a flue gas desulfurization plant with TDS of about 30,000 to 50,000 mg/l were also examined. Reverse osmosis plants treating cooling tower blow down with a reject concentrate TDS in the range of 35,000 to 65,000 mg/l was also reviewed. Sea water reverse osmosis plants with TDS of about 65,000 mg/l in the concentrate were considered.

Test Results

A laboratory study on a typical cooling tower blow down waste water was carried out with high hardness and silica. The laboratory test was based on a TDS of 18,000 mg/l in the RO reject, and this value was considered based on a average value of such operating system. However these results can be replicated for much higher TDS of up to 60,000 mg/l in the clarification softening and up to 80,000 mg/l or about in the RO concentrate TDS.

For this purpose a synthetic water was considered with a blend analysis of about 10,000 mg/l TDS and containing Ca at about 368 mg/l as CaCO3, Mg at about 112 mg/l as CaCO3, HCO₃ at about 218 mg/l as CaCO3, Cl at about 4118 mg/l, SO₄ at about 2108 mg/l, Sodium at about 3642 mg/l and silica as SiO₂ at about 120 mg/l. This is listed in the column 3 of the table 1 below.

The blend synthetic water was produced by addition of various chemicals. Chemicals added were calcium chloride, sodium chloride, sodium sulfate, sodium nitrate and potassium chloride, salts of silicate etc.

The ionic values indicated in the table 1 and 2 below are rounded up values. The softening process was carried out in the laboratory using the synthetic blend water with analysis as detailed above. The flow rates indicated in the table 1 and 2 below is hypothetical flows for RO simulation purpose.

The softening of the synthetic water was carried out in the laboratory by adding soda ash (600 mg/l) and calcium hydroxide (300 mg/l) to a 1 liter water sample. Solutions were slowly agitated and then allowed for 120 minutes retention time. The PH of the solution was noted at about 11. The samples were then analyzed for calcium, magnesium, alkalinity, silica and other constituents. The soft water analysis appears in column 4 of table 1.

Softened water was then neutralized by hydrochloric acid to a ph of 8.3 and chloride level increase was noted. The results are provided in column 5 of table 2. A RO projection modeling was then carried out considering the softened and acid neutralized water as feed to the RO. The detailed feed water analysis is shown under column 5 of table 2. DOW FILMTEC® ROSA program was used for this projection. The membrane considered is FILMTEC® BW30-4040 brackish water elements. The feed water temperature considered is 77° F. and feed pH at 8.3. The membrane array considered is a single stage of 1 pressure vessel with 4 elements with a total area of 328 ft2. SDI was assumed as less than 5 like any normal RO system. The feed flow considered is 7.5 gpm and the permeate production at 3 gpm thus operating at 40% recovery based on feed flow. The reject quantity from the RO concentrate side is 4.5 gpm. The projection results indicated an operating flux of 13 GFD and showed no design warnings. The silica saturation level was only 87%. The analysis of the RO reject is listed in column 2 of table 1 as well in column 6 and 7 of table 2.

TABLE 1

| | | | Blended Feed to softening | Soft water after addition of |
|---|---|---|---|---|
| | | Recycle water from | unit (blend of column 1 | coagulant Ferric Sulfate, |
| | Feed Raw water | RO Reject Simulated | and 2) Actual water sample | hydrated lime and soda ash for |
| | Simulated | as per RO projection | synthesized for lab use | precipitation. (Actual Lab testing) |
| Details | Column 1 | Column 2 | Column 3 | Column 4 |
| Flow gpm | 3.3 | 4.2 | 7.5 | 7.5 |
| Ca, mg/l as | 760 | 60 | 368 | 36 |
| CaCO₃ | | | | |
| Mg, mg/l as | 161.2 | 73.3 | 112 | 44 |
| CaCO₃ | | | | |
| Bicarbonate | 108.4 | 304.1 | 218 | 0 |
| mg/l, as CaCO₃ | | | | |
| Carbonate as | | | | 372 |
| CaCO₃ | | | | |
| Silica as SiO₂ | 107.8 | 129.6 | 120 | 78 |
| (mg/l) | | | | |
| Chloride Cl, mg/l | 336.7 | 7089 | 4118 | 4118 |
| Sulfate SO₄, mg/l | 288 | 3538 | 2108 | 2130 |
| Sodium Na, mg/l | 44 | 6469 | 3642 | 3902 |
| Potassium K, mg/l | 16.5 | 97.7 | 62 | 62 |
| Nitrate NO₃, mg/l | 88.4 | 369 | 383 | 383 |
| TDS, mg/l | ~1300 | | ~10,700 | |
| pH | 7.7 | 8.1 | 7.9 | 11 |

TABLE 2

| | | RO Reject quality for recycle based | |
|---|---|---|---|
| | Feed to RO after HCL | on 40% recovery & 3 gpm permeate. | |
| | addition for pH reduction. | Membrane projection attached. | RO reject for |
| | (Actual Lab testing) | (Simulated modeling) | disposal |
| Details | Column 5 | Column 6 | Column 7 |
| Flow gpm | 7.5 | 4.2 | 0.3 |
| Ca, mg/l as CaCO₃ | 36 | 60 | 60 |
| Mg, mg/l as CaCO₃ | 44 | 73.3 | 73.3 |
| Bicarbonate mg/l, as | 185 | 304.1 | 304.1 |
| CaCO₃ | | | |
| Carbonate as CaCO₃ | | | |
| Silica as SiO₂ (mg/l) | 78 | 129.6 | 129.6 |
| Chloride Cl, mg/l | 4274 | 7089 | 7089 |
| Sulfate SO₄, mg/l | 2130 | 3538 | 3538 |
| Sodium Na, mg/l | 3902 | 6469 | 6469 |
| Potassium K, mg/l | 62 | 97.7 | 97.7 |
| Nitrate NO₃, mg/l | 383 | 369 | 369 |
| TDS, mg/l | ~11,000 | ~18,100 | ~18,100 |
| pH | 8.3 | 8.1 | 8.1 |

Based on the above the RO membrane process is operating at 90% recovery overall with multiple passes but actual recovery of only 40% in a single pass. As would be noted from table 1 column 1, the feed flow is 3.3 gpm and the reject for disposal is 0.3 gpm as per column 7 of table 2. This is a recovery of 90% of the feed flow. Also with this process the softening clarifier is operating at a TDS of about 11,000 mg/l where as the RO reject is at about 18,000 mg/l TDS. The silica reduction in the softener is only 78 mg/l from 120 mg/l in the feed. But still a 90% recovery of feed flow is possible without any scaling or fouling of the membrane. It can also be verified from the RO projection that the RO is operating at a low flux of 13 GFD and a feed pressure of 300 psig without any design warning treating a high TDS feed water with high silica and hardness and also operating at high recovery. The silica percentage saturation in the RO concentrate is only 88%, which is well below saturation level.

I claim:

1. A method of producing a treated permeate and recycled reverse osmosis concentrate, comprising:
(a) providing feed water containing hardness and sparingly soluble salts;
(b) in a tank, precipitating a portion of said hardness and said sparingly soluble salts from said feedwater, producing precipitated salts and partially purified feedwater;
(c) coagulating said precipitated salts and allowing them to settle in said tank;
(d) stopping the precipitation process;
(e) filtering the partially purified feedwater;
(f) feeding the filtered, partially purified feedwater to a single-pass reverse osmosis (RO) unit, producing a treated permeate and an RO concentrate; and
(g) recycling a portion of the RO concentrate and mixing it with the feedwater prior to or during the precipitation step.

2. The method of claim 1, further comprising softening said feedwater prior to the precipitation step.

3. The method of claim 1, wherein the precipitation process is stopped by acid neutralization.

4. The method of claim 1, including chlorinating said feedwater.

5. The method of claim 1, wherein said filtering is conducted by providing said partially purified feedwater to a member of the group consisting of a single-stage media filter, a multi-stage media filter, a microfiltration membrane, and an ultrafiltration membrane.

6. The method of claim 1, comprising providing a portion of the partially purified water to a cooling tower prior to filtration.

7. The method of claim 1, wherein said RO unit operates between 50% to 75% recovery.

8. The method of claim 1, wherein said RO united operates at or below 50% recovery.

9. The method of claim 1, wherein the precipitation occurs in a member of the group consisting of a softening clarifier; a solid contact clarifier; and a series consisting of a flash mixer, flocculator, and settling tank.

10. The method of claim 1, wherein said precipitation step occurs at a higher total dissolved solids than is present in said feedwater.

11. The method of claim 1, wherein said precipitation occurs in a clarifier, and said filtering, filters only the supernatant from the clarifier in which most of the suspended solids are already settled and removed in the clarifier.

12. The method of claim 1, wherein said precipitation occurs in a clarifier, and wherein suspended solids in the clarifier are removed as underflow to maintain a desired suspended solids level in the clarifier.

13. The method of claim 11, wherein the level of total dissolved solids in the clarifier is less than the level of total dissolved solids in the RO concentrate.

14. The method of claim 1, wherein said precipitation occurs in a softening clarifier, and said clarifier operates at a total dissolved solids up to and including 60,000 mg/l.

15. The method of claim 1, wherein a portion of the RO concentrate is disposed of as RO reject prior to recycling.

16. A method of producing a treated permeate, comprising:
(a) providing feedwater containing hardness and sparingly soluble salts;
(b) in a tank, precipitating a portion of said hardness and said sparingly soluble salts from said feedwater, producing precipitated salts and partially purified feedwater;
(c) coagulating said precipitated salts and allowing them to settle in said tank;
(d) stopping the precipitation process;
(e) filtering the partially purified feedwater;
(f) feeding the filtered, partially purified feedwater to a single-pass reverse osmosis (RO) unit operating at less than or equal to 75% recovery of the feed flow, producing a treated permeate.

17. A reverse osmosis system carrying out the process of claim 1 at a total dissolved solids level of up to and including about 95,000 mg/l TDS.

18. The reverse osmosis system of claim 17, wherein said system operates at high cross flow velocity due to low recovery.

19. The method of claim 1, wherein said RO process operates at less than or equal to 80% recovery based on RO feed flow and wherein total recovery is at least about 98% overall recovery relative to a system makeup feed flow.

20. The method of claim 1, wherein said RO process operates at less than or equal to 40% recovery based on RO feed flow and wherein total recovery is at least about 90% overall recovery relative to a system makeup feed flow.
